(19) United States
(12) Patent Application Publication
(10) Pub. No.: US 2011/0107245 A1
(43) Pub. Date: May 5, 2011

(54) ELECTRONIC PROFILE CREATION

(75) Inventors: James Dantzler, Seattle, WA (US); Brian Fioca, Seattle, WA (US); Anthony Wright, Seattle, WA (US); Jessica Scheibach, Seattle, WA (US); Ryan Kuykendall, Seattle, WA (US)

(73) Assignee: JOBSTER, INCORPORATED, Seattle, WA (US)

(21) Appl. No.: 11/758,420

(22) Filed: Jun. 5, 2007

Related U.S. Application Data
(60) Provisional application No. 60/862,849, filed on Oct. 25, 2006.
(60) Provisional application No. 60/823,821, filed on Aug. 29, 2006.
(60) Provisional application No. 60/820,583, filed on Jul. 27, 2006.
(60) Provisional application No. 60/822,780, filed on Aug. 18, 2006.

(51) Int. Cl. G06F 3/048

(52) U.S. Cl. 715/769; 715/810; 715/835

(57) ABSTRACT

A method implementable in an electronic system coupled to an electronic device, which is, in turn, coupled to a display device. In an embodiment, a first set of selectable tags is generated, each of the first-set tags corresponding to a respective vocational characteristic. In response to first user input, a displayable selection field is populated with a first subset of the selectable tags. In response to second user input, the first-subset tags are ranked according to relevance to at least one quality of the user. A profile of the user is generated using at least one ranked tag.

### PRIORITY CLAIM

The present application claims priority from U.S. Provisional Application No. 60/862,849 filed Oct. 25, 2006 and U.S. Provisional Application No. 60/823,821 filed Aug. 29, 2006, which are, along with commonly owned and co-pending U.S. Provisional Application No. 60/820,583 filed Jul. 27, 2006; U.S. Provisional Application Ser. No. 60/822,780 filed Aug. 18, 2006; U.S. patent application Ser. No. 11/083,029 filed Mar. 18, 2005 and U.S. patent application Ser. No. 11/083,950 filed Mar. 18, 2005, and U.S. patent application Ser. No. 11/082,935 filed Mar. 18, 2005 and U.S. Provisional Application Ser. No. 60/938,135 filed May 15, 2007 all are herein incorporated by reference.

### FIELD OF THE INVENTION

This invention relates generally to computer-implemented processes and, more specifically, to generation of electronic user profiles.

### BACKGROUND OF THE INVENTION

Methods and apparatus involving job searching and placement services are known in the art. Such methods and apparatus are offered, for example, on well known Internet Web sites.

The known methods and apparatus, however, fail to adequately filter prospective candidates or reach passive prospective candidates (i.e., those not presently actively seeking jobs). As such, the company or recruiter looking for prospective candidates may be inundated with resumes, many of which are not close to the type or quality of candidates the company or recruiter is looking for. Likewise, the known methods and apparatus fail to provide a way for candidates to conveniently and concisely identify their professional strengths and or strong interests to better enable being quickly located by an employer with whom the candidate would be a good fit.

Other problems with the prior art not described above can also be overcome using the teachings of embodiments of the present invention, as would be readily apparent to one of ordinary skill in the art after reading this disclosure.

### SUMMARY OF THE INVENTION

In an embodiment, a method is implementable in an electronic system coupled to an electronic device, which is, in turn, coupled to a display device. A first set of selectable tags is generated, each of the first-set tags corresponding to a respective vocational characteristic. In response to first user input, a displayable selection field is populated with a first subset of the selectable tags. In response to second user input, the first-subset tags are ranked according to relevance to at least one quality of the user. A profile of the user is generated using at least one ranked tag.

### BRIEF DESCRIPTION OF THE DRAWINGS

Preferred and alternative embodiments of the present invention are described in detail below with reference to the following drawings.

FIG. 1 is a schematic view of an exemplary operating environment in which an embodiment of the invention can be implemented;

FIG. 2 is a functional block diagram of an exemplary operating environment in which an embodiment of the invention can be implemented;

FIG. 3 is a schematic view of a graphical user interface (GUI) according to an embodiment of the invention;

FIG. 4 is a schematic view of a GUI according to an embodiment of the invention;

FIG. 5 is a schematic view of a GUI according to an embodiment of the invention;

FIG. 6 is a schematic view of a GUI according to an embodiment of the invention;

FIG. 7 is a flow diagram illustrating a first method according to an embodiment of the invention;

FIG. 8 is a flow diagram illustrating a second method according to an embodiment of the invention; and

FIG. 9 is a flow diagram illustrating a third method according to an embodiment of the invention.

### DETAILED DESCRIPTION OF THE PREFERRED EMBODIMENT

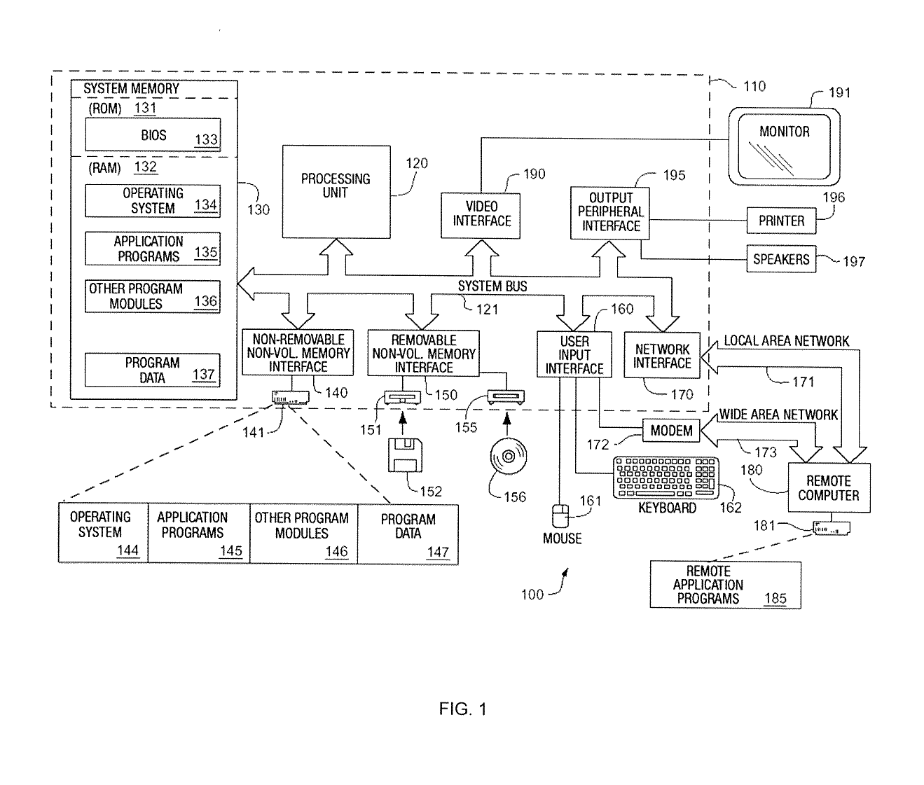

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

Embodiments of the invention are operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Embodiments of the invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

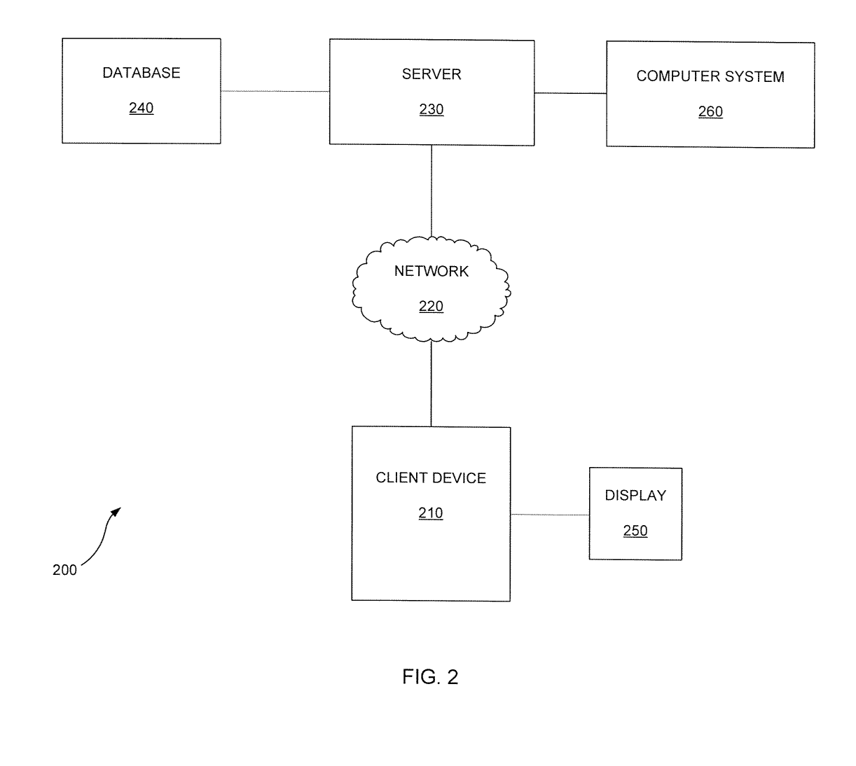

Referring now to FIG. 2, an embodiment of the present invention can be described in the context of an exemplary computer network system 200 as illustrated. System 200 includes an electronic client device 210, such as a personal computer or workstation, that is linked via a communication medium, such as a network 220 (e.g., the Internet), to an electronic device or system, such as a server 230. The server 230 may further be coupled, or otherwise have access, to a database 240 and a computer system 260. Although the embodiment illustrated in FIG. 2 includes one server 230 coupled to one client device 210 via the network 220, it should be recognized that embodiments of the invention may be implemented using one or more such client devices coupled to one or more such servers.

In an embodiment, each of the client device 210 and server 230 may include all or fewer than all of the features associated with the computer 110 illustrated in and discussed with reference to FIG. 1. Client device 210 includes or is otherwise coupled to a computer screen or display 250. Client device 210 can be used for various purposes including both network- and local-computing processes.

The client device 210 is linked via the network 220 to server 230 so that computer programs, such as, for example, a browser, running on the client device 210 can cooperate in two-way communication with server 230. Server 230 may be coupled to database 240 to retrieve information therefrom and to store information thereto. Database 240 may include a plurality of different tables (not shown) that can be used by server 230 to enable performance of various aspects of embodiments of the invention. Additionally, the server 230 may be coupled to the computer system 260 in a manner allowing the server to delegate certain processing functions to the computer system.

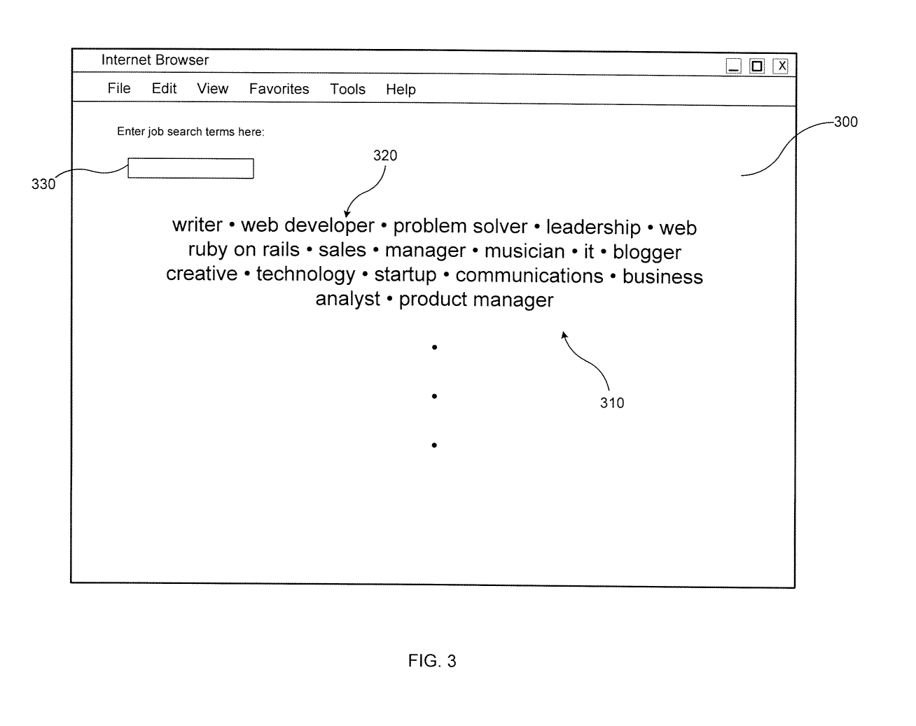

Still referring to FIG. 2, and in operation according to an embodiment of the invention, a user (not shown) of the client device 210 desiring to prepare an electronic profile describing qualities (e.g., professional qualifications) of the user uses a browser application running on the client device to access web content served by the server 230. Specifically, and referring to FIG. 3, by employing an appropriate uniform resource locator (URL) in a known manner, the user may request a web page 300 to be displayed on the display device 250. As is discussed in further detail below, the web page 300 provides a graphical user interface that allows the user to input or otherwise select data from which a user profile may be prepared.

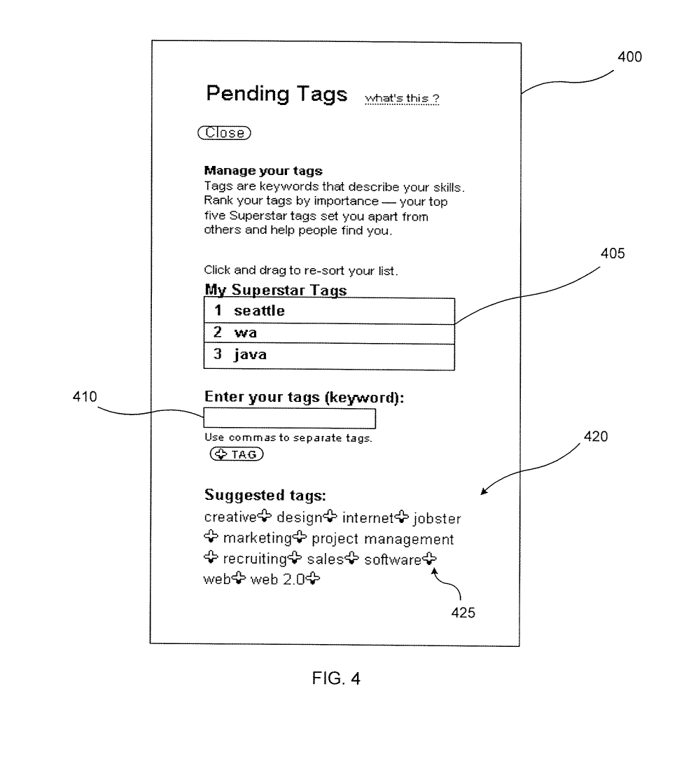

In an embodiment, and still referring to FIG. 3, the displayed web page 300 includes a set of selectable tags 310. Each of the tags 310 is descriptive of a vocational characteristic that may be used to at least partially describe a user. These vocational-characteristic qualities that the tags 310 describe may include, by way of non-limiting example, areas of specific vocational expertise, educational institutions attended, hobbies, and general ability. Moreover, each of the tags 310 may be displayed on the page 300 as an object that may be indicated and/or selected by a user via, for example, a conventional point-and-click device, such as a mouse. For example, in the process of preparing a profile, a user may click on or otherwise select the “web developer” tag 320 to indicate that he or she has professional experience as, or may be interesting in becoming, a web developer. Alternatively, and as discussed in further detail below herein, a tag 310 may include a hyperlink to one or more pages including tags that are topically related to the tag 310. In this latter embodiment, a user can point a mouse to a particular tag 310 to invoke a selectable icon, such as a plus sign 425 (FIG. 4), associated with the particular tag. The user may then associate the particular tag 310 with himself/herself (e.g., add the tag to a personal profile) by clicking on the selectable icon rather than the tag 310 itself.

In an embodiment, the user may influence the types of tags 310 displayed on the page 300 by inputting into a data-entry field 330 one or more search terms directed to a particular topic. In response to the entry of search terms, the page 300 may be drawn or redrawn to display only tags 310 that include one or more of the search terms. For example, if the user entered the term “web” into the field 330, the page 300 may be drawn or redrawn to display tags 310 such as, for example, “web developer,” or “web hosting.” As such, the user is able to quickly locate only the tags 310 most relevant to creating the desired profile.

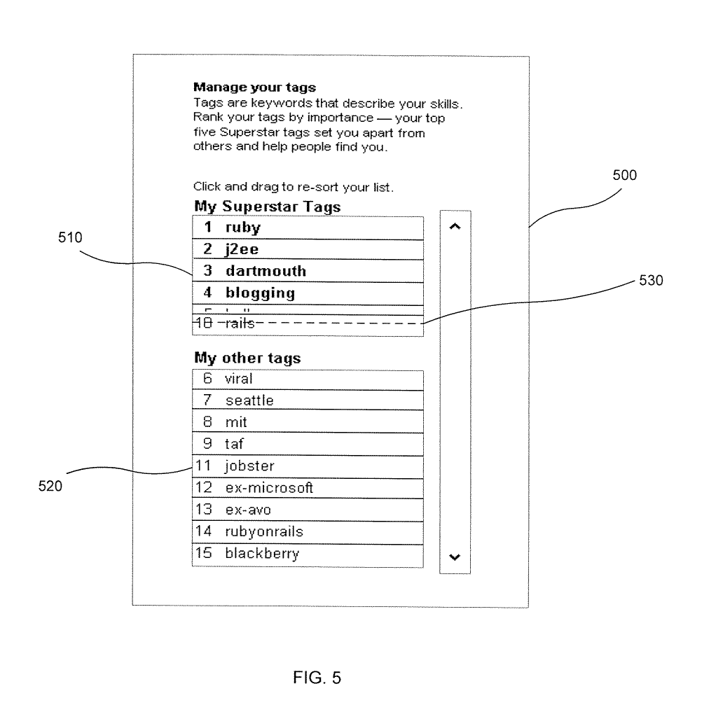

In an embodiment, and as will be discussed in greater detail below, each tag 310 selected by a user is added to the user's profile, which may be stored, for example, in the database 240. In an embodiment, the selected tags 310 may be temporarily accumulated in a conventional “shopping-cart” manner thereby allowing the user to later decide which of the selected tags are actually added to the profile or used to create a new profile. Regardless, a profile should be understood to include any data set created by a particular user irrespective of whether such user has, in the course of interacting with the page 300 or any web page linked thereto, previously provided their name or any other personal info. As such, a shopping cart populated with one or more tags may be considered a profile of a user, albeit, perhaps, an anonymous user. To better facilitate this function, and referring to FIG. 4, the user may cause the browser to invoke a pending-tags interface 400 that allows the user to view the tags that he or she has selected in a particular session. As will be discussed in greater detail with reference to FIG. 5, the user may also rank the tags displayed in the interface 400 by using drag-and-drop portion 405 of the interface.

In an embodiment, and still referring to FIG. 4, the user may employ the interface 400 to accumulate additional pending tags. For example, the user may choose to directly enter into a data-entry field 410 a term for use as a tag. Additionally, the interface 400 may include a set of selectable tags 420 that, in an embodiment, are related to the already-accumulated tags.

In an embodiment, and as illustrated in FIG. 5, the user may cause the browser to invoke a selection field including a ranking interface 500 that allows the user to rank the tags that he or she has thus far accumulated. Two ranking fields 510, 520 of the interface 500 allow the user to reorder their tags by priority. As highlighted by the dashed line whereby the user is causing the 10^{th}-ranked tag to supplant the 5^{th}-ranked tag, the fields 510, 520 may include drag-and-drop functionality. The user may choose five tags, for example, that the user thinks best describe or wishes to emphasize about the user. As such the user may designate these five tags as “Superstar” tags by placing them into the field 510. As discussed in greater detail in the related and co-pending applications incorporated by reference above, the Superstar tags may receive special priority in profile ranking and display within the profile. Alternatively, of course the ranking fields 510, 520 may be combined to form a unitary field from which only a predetermined number of highest-ranked tags receive such priority.

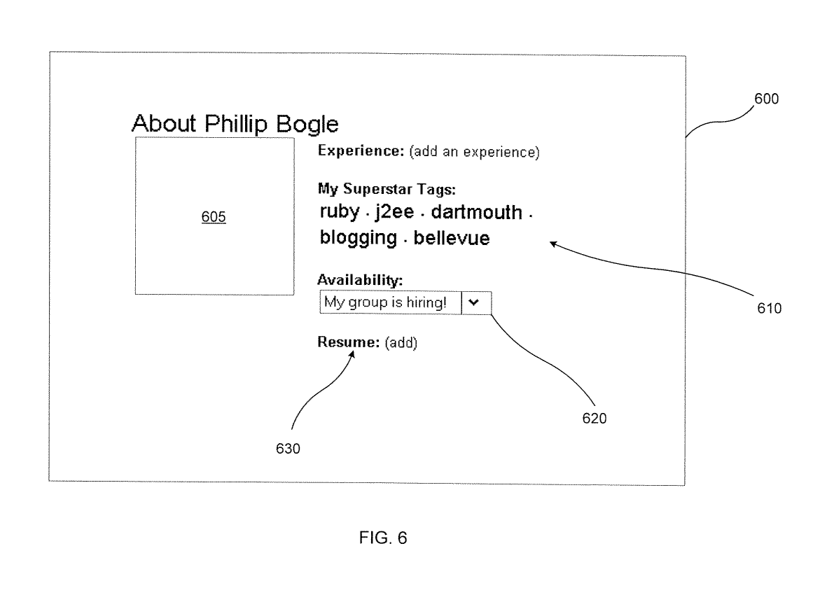

FIG. 6 illustrates a user profile page 600 according to an embodiment of the invention that may include a photograph/avatar 605 of the profiled person. As illustrated, the Superstar tags are prominently displayed in a “My Tags” portion 610 of the page 600. In the illustrated embodiment, the profile page 600 includes an employment-status interface, such as, for example, a drop-down menu 620, that allows the user to indicate their availability as a new hire or whether a company with which the user is affiliated is hiring. The page 600 may further include a link 630 that allows the user to associate a resume with their profile or to provide a resume to the profiled person.

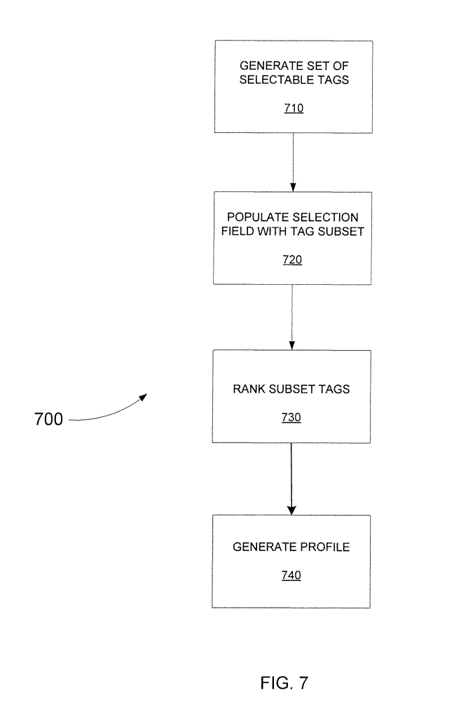

FIG. 7 illustrates a process 700 according to an embodiment of the invention. The process is implementable in an electronic system coupled to an electronic device, the electronic device being coupled to a display device. The process 700 is illustrated as a set of operations shown as discrete blocks. The process 700 may be implemented in any suitable hardware, software, firmware, or combination thereof. The order in which the operations are described is not to be necessarily construed as a limitation.

At a block 710, a first set of selectable tags is generated. Each of the first-set tags corresponds to a respective vocational characteristic that may be used to describe, for example, a job candidate or potential employer. In an embodiment, at least one of the tags may be generated in response to data input by a user. For example, the user may influence the types of tags 310 displayed on the page 300 by inputting into a data-entry field 330 one or more search terms directed to a particular topic. In response to the entry of search terms, the page 300 may be drawn or redrawn to display only tags 310 that include one or more of the search terms. Alternatively, the page 300 may be drawn or redrawn to display one or more tags 310 that correspond to a vocational characteristic related to, but not necessarily including, one or more of the search terms.

At a block 720, in response to first input of a user, a displayable selection field is populated with a first subset of the selectable tags. For example, each tag 310 selected by a user may be added to the user's profile, which may be stored, for example, in the database 240.

In an embodiment, the first user input may include selecting at least one of the first-subset tags from a selection field generated within a user interface. For example, each of the tags 310 may be displayed on the page 300 as an object that may be selected by a user via, for example, a conventional point-and-click device, such as a mouse. Alternatively, the first user input comprises creating an electronic account. For example, if the user has not previously created a profile, the user may do so in order to populate the newly created profile with tags that the user has accumulated in an electronic “shopping cart.”

At a block 730, in response to second input of the user, the first-subset tags are ranked according to relevance to at least one quality (e.g., type of employment sought) of the user. For example, the user may drag and drop tags within the ranking fields 510, 520 of the interface 500. In an embodiment, the second user input includes placing a predetermined number of most relevant tags in the first subfield. For example, the user may choose five tags that the user thinks best describe or wishes to emphasize about the user. As such, the user may designate these five tags as “Superstar” tags by placing them into the field 510.

At a block 740, a profile of the user is generated using at least one ranked tag. In an embodiment, the profile is generated using only tags placed in the first subfield. For example, the profile page 600 may include only the tags designated by the user as Superstar tags. Alternatively, the profile is generated using only first-subset tags of at least a predetermined rank. For example, the ranking fields 510, 520 may be combined to form a unitary field from which only a predetermined number of highest-ranked tags are included in the profile page 600.

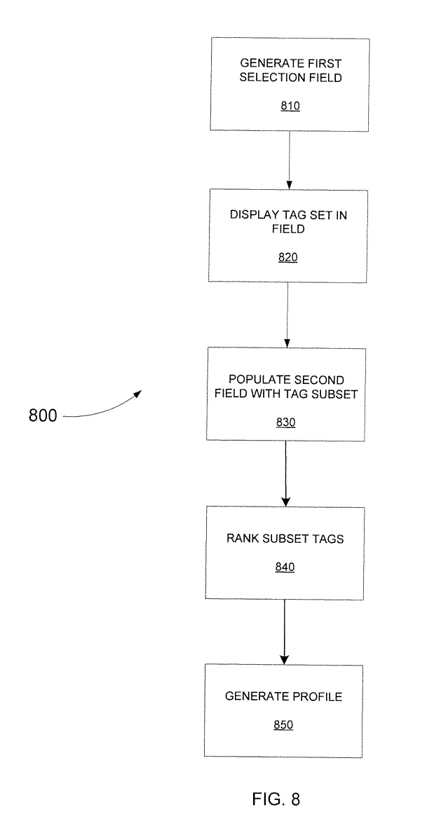

FIG. 8 illustrates a process 800 according to an embodiment of the invention. The process is implementable in an electronic system coupled to an electronic device, the electronic device being coupled to a display device. The process 800 is illustrated as a set of operations shown as discrete blocks. The process 800 may be implemented in any suitable hardware, software, firmware, or combination thereof. The order in which the operations are described is not to be necessarily construed as a limitation.

At a block 810, a first selection field is generated in a user interface. For example, the displayed web page 300 includes a set of selectable tags 310. In an embodiment, the web page 300 is served to an electronic device through a network.

At a block 820, a first set of selectable tags is displayed in the first selection field. Each of the first-set tags corresponds to a respective vocational characteristic that may be used to describe, for example, a job candidate or potential employer.

At a block 830, in response to first input of a user, a second field is populated with a first subset of the selectable tags. For example, by selecting one or more of the tags 310 from the page 300, the user may populate the pending-tags interface 400. In an embodiment, the second field is a selection field and may comprise first and second subfields, such as the ranking fields 510, 520 of the interface 500.

At a block 840, in response to second input of the user, the first-subset tags are ranked according to relevance to at least one quality (e.g., type of employment sought) of the user. For example, the user may drag and drop tags within the pending-tags interface 400 in a manner similar to that discussed with reference to FIG. 5. In an embodiment, the second user input comprises placing a predetermined number of most relevant tags in the first subfield. For example, the user may choose five tags that the user thinks best describe or wishes to emphasize about the user. As such, the user may designate these five tags as “Superstar” tags by placing them into the field 510.

At a block 850, a profile of the user, such as that displayed in the profile page 600, is generated using at least one tag of the first subset. In an embodiment, the profile is generated using only tags placed in the first subfield. For example, the profile page 600 may include only the tags designated by the user as Superstar tags. Alternatively, the profile is generated using only first-subset tags of at least a predetermined rank. For example, the ranking fields 510, 520 may be combined to form a unitary field from which only a predetermined number of highest-ranked tags are included in the profile page 600.

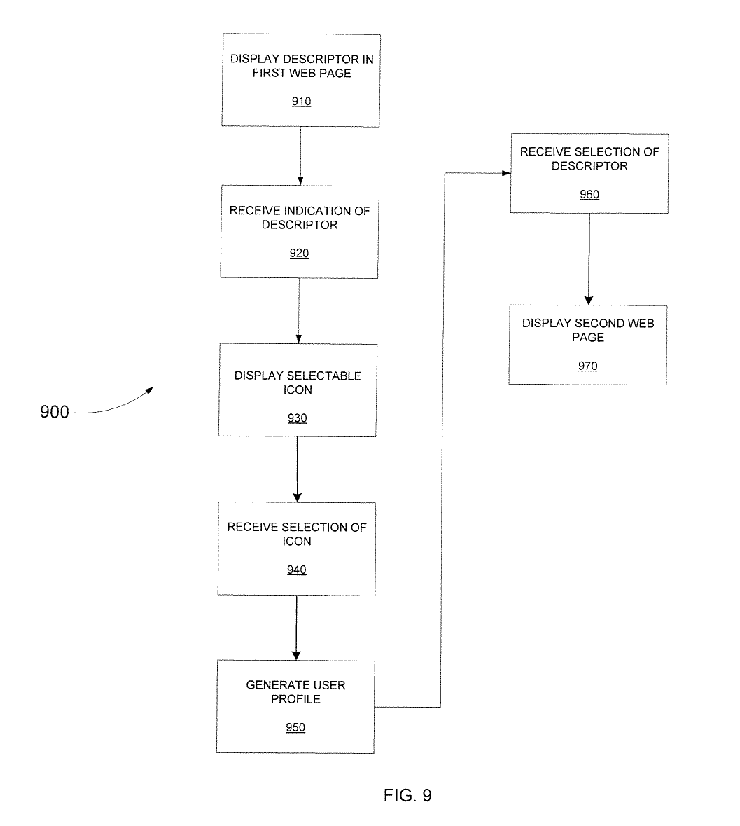

FIG. 9 illustrates a process 900 according to an embodiment of the invention. The process is implementable in an electronic system coupled to an electronic device, the electronic device being coupled to a display device. The process 900 is illustrated as a set of operations shown as discrete blocks. The process 900 may be implemented in any suitable hardware, software, firmware, or combination thereof. The order in which the operations are described is not to be necessarily construed as a limitation.

At a block 910, at least one descriptor of a first vocational characteristic is displayed in a first web page. For example, the displayed web page 300 includes a set of selectable tags 310. In an embodiment, the first web page is served to an electronic device through a network. The vocational characteristic may be used to describe, for example, a job candidate or potential employer.

At a block 920, an indication of the descriptor is received from a user. For example, a user can point a mouse to a particular tag 310.

At a block 930, in response to the indication, a selectable icon is displayed in the page. For example, by pointing the mouse to a particular tag 310, the user may invoke a selectable icon 425 associated with the particular tag.

At a block 940, a selection of the icon is received from the user. For example, the user may click on the selectable icon.

At a block 950, in response to the icon selection, a profile of the user including a description of the first vocational characteristic is generated. For example, the profile page 600 may include the descriptor (e.g., tag) associated with and/or describing the first vocational characteristic. In connection with the description herein of varying embodiments, the term “generating a profile” contemplates both the initial creation of a profile and modification of an existing profile. Moreover, a profile should be understood to include any data set created by a particular user irrespective of whether such user has provided their name or any other personal info. A shopping cart populated with one or more tags may be considered a profile of a user.

At a block 960, a selection of the descriptor is received. For example, in an embodiment, a tag 310 may include a hyperlink. As such, a user may use a mouse or other appropriate selection device to select the tag 310.

At a block 970, in response to receiving the hyperlink selection, a second web page is displayed. The second web page includes a hyperlink describing a second vocational characteristic topically related to the first vocational characteristic. For example, a tag 310 may include a hyperlink to one or more pages including tags that are topically related to the tag 310.

While a preferred embodiment of the invention has been illustrated and described, as noted above, many changes can be made without departing from the spirit and scope of the invention. Instead, the invention should be determined entirely by reference to the claims that follow.

The embodiments of the invention in which an exclusive property or privilege is claimed are defined as follows:

1. A computer-readable medium having computer-executable instructions for performing steps comprising:
generating a first set of selectable tags, each of the first-set tags corresponding to a respective vocational characteristic;
in response to first input of a user, populating a displayable selection field with a first subset of the selectable tags;
in response to second input of the user, ranking the first-subset tags according to relevance to at least one quality of the user; and
generating a profile of the user using at least one ranked tag.

2. The medium of claim 1 wherein at least one of the first-set tags is generated in response to data input by the user.

3. The medium of claim 2 wherein the data comprises a search string.

4. The medium of claim 3 wherein the at least one first-set tag comprises a term of the search string.

5. The medium of claim 3 wherein the at least one first-set tag corresponds to a vocational characteristic related to a term of the search string.

6. The medium of claim 1 wherein the first user input comprises selecting at least one of the first-subset tags from a selection field generated within a user interface.

7. The medium of claim 1 wherein the first user input comprises creating an electronic account.

8. The medium of claim 1 wherein the second user input comprises dragging and dropping the first-subset tags within the selection field.

9. The medium of claim 1 wherein the selection field comprises first and second subfields.

10. The medium of claim 1 wherein the second user input comprises placing a predetermined number of most relevant tags in the first subfield.

11. The medium of claim 10 wherein the profile is generated using only tags placed in the first subfield.

12. The medium of claim 1 wherein the profile is generated using only first-subset tags of at least a predetermined rank.

13. A computer-readable medium having computer-executable instructions for performing steps comprising:
generating in a user interface a first selection field;
displaying in the first selection field a first set of selectable tags, each of the first-set tags corresponding to a respective vocational characteristic;
in response to first input of a user, populating a second field with a first subset of the selectable tags; and
generating a profile of the user using at least one tag of the first subset.

14. The medium of claim 13 wherein the first user input comprises selecting at least one of the first-set tags from the first selection field.

15. The medium of claim 13, further comprising in response to second input of the user, ranking the first-subset tags according to relevance to at least one quality of the user.

16. The medium of claim 15 wherein the second user input comprises dragging and dropping the first-subset tags within the second selection field.

17. The medium of claim 15 wherein the second selection field comprises first and second subfields.

18. The medium of claim 17 wherein the second user input comprises placing a predetermined number of most relevant tags in the first subfield.

19. The medium of claim 18 wherein the profile is generated using only tags placed in the first subfield.

20. The medium of claim 15 wherein the profile is generated using only first-subset tags of at least a predetermined rank.

21. A method implementable in an electronic system, comprising the steps of:
displaying in a first web page at least one descriptor of a first vocational characteristic;
receiving from a user an indication of the descriptor;
in response to the indication, displaying in the page a selectable icon;
receiving from the user a selection of the icon; and
in response to the icon selection, generating a profile of the user including a description of the first vocational characteristic.

22. The method of claim 21, wherein the descriptor comprises a hyperlink.

23. The method of claim 22, further comprising:
receiving a selection of the hyperlink; and
in response to receiving the hyperlink selection, displaying a second web page including a hyperlink describing a second vocational characteristic topically related to the first vocational characteristic.
